(19) United States
(12) Patent Application Publication
(10) Pub. No.: US 2014/0238643 A1
(43) Pub. Date: Aug. 28, 2014

(54) SYSTEM AND METHOD FOR CLEANING HEAT EXCHANGERS

(71) Applicant: GENERAL ELECTRIC COMPANY, Schenectady, NY (US)

(72) Inventors: John Victor Hains, Simpsonville, SC (US); Steven David Stovall, Anderson, SC (US); Eddwin Alejandro Granados, Queretaro (MX)

(73) Assignee: GENERAL ELECTRIC COMPANY, Schenectady, NY (US)

(21) Appl. No.: 13/774,733

(22) Filed: Feb. 22, 2013

(51) Int. Cl. F28G 9/00; B08B 7/00

(52) U.S. Cl. CPC F28G 9/00; B08B 7/00
USPC 165/95; 134/56 R

(57) ABSTRACT

A system includes a cooling system and a cleaning system. The cooling system has a first pump, a heat exchanger, a liquid flow path through the first pump and the heat exchanger, a first cooling fan, and an airflow path through the first cooling fan and along an exterior surface of the heat exchanger. The cleaning system has at least one fluid outlet that may direct a fluid jet against the exterior surface of the heat exchanger to clean the exterior surface during operation of the cooling system.

### BACKGROUND OF THE INVENTION

The subject matter disclosed herein relates to heat transfer systems, and more specifically, to systems and methods for cleaning the heat transfer systems associated with various equipment such as gas turbine systems.

Heat transfer systems generally include a heat exchanger that transfers heat between two fluids. For example, a hot fluid may flow in a concurrent or countercurrent arrangement relative to a flow of cold fluid. As a result, the hot fluid decreases in temperature and the cold fluid increases in temperature. Unfortunately, the heat exchange efficiency gradually decreases over time due to fouling of heat exchanging surfaces. The decrease in heat exchanger efficiency may increase utility consumption and costs, while also decreasing performance and/or efficiency of systems (e.g., gas turbine systems) using the heat exchanger.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system includes a cooling system and a cleaning system. The cooling system includes a first pump, a heat exchanger, a liquid flow path through the first pump and the heat exchanger, a first cooling fan, and an airflow path through the first cooling fan and along an exterior surface of the heat exchanger. The cleaning system includes at least one fluid outlet that may direct a fluid jet against the exterior surface of the heat exchanger to clean the exterior surface during operation of the cooling system.

In a second embodiment, a system includes a cleaning system having at least one fluid outlet that may direct a fluid jet against an exterior surface of a heat exchanger to clean the exterior surface during operation of a cooling system.

In a third embodiment, a system includes a cleaning system controller having a non-transitory, machine-readable medium having instructions executable by a processor. The instructions include estimating a parameter indicative of heat transfer efficiency using feedback from one or more sensors, determining if the parameter is within a range, and enabling flow of a cleaning fluid along an exterior surface of an air-cooled heat exchanger when the parameter is within the range.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a gas turbine system coupled to a cooling system equipped with a cleaning system to improve the efficiency of the cooling system;

FIG. 2 is a block diagram of an embodiment of the cooling system of FIG. 1, illustrating one or more cleaning fluid supplies used to clean one or more heat exchangers for various downstream systems;

FIG. 3 is a schematic diagram of an embodiment the heat exchanger of FIG. 1, illustrating a plurality of finned tubes that may be cooled by the cleaning system;

FIG. 4 is a flowchart of an embodiment of a method to clean the cooling system of FIG. 1;

FIG. 5 is a partial schematic view of an embodiment of a cleaning fluid distribution manifold having a plurality of orifices; and

FIG. 6 is a partial schematic view of an embodiment of a cleaning fluid distribution manifold having a plurality of nozzles oriented at varying angles.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed towards system and methods to clean heat exchangers. In particular, a cleaning system may direct a cleaning fluid along an exterior surface (e.g., walls of fins, tubes, enclosures, etc.) of the heat exchanger in order to clear fouling and debris that accumulates on the exterior surface. For example, the cleaning fluid may be a cleaning gas (e.g., air, nitrogen, exhaust gas, etc.), and the cleaning system may direct pulses of compressed gas (e.g., air) or a continuous flow of pressurized gas (e.g., air) along the exterior surface of the heat exchanger. The cleaning system may include sensors and controllers to enable automatic activation of the cleaning system. That is, the sensors may detect a decrease in cooling efficiency, and the controller may open one or more valves to enable flow of the cleaning fluid across the exterior surface of the heat exchanger. Advantageously, the cleaning system may be used during operation of the heat exchanger, thereby enabling the heat exchanger to be cleaned without taking the heat exchanger offline. In turn, the system relying on the heat exchanger may remain online, thereby reducing various losses associated with offline maintenance. For example, the continuous operation of the heat exchanger may be particularly useful in commercial and industrial systems, such as power generation systems, gas turbine systems, and the like.

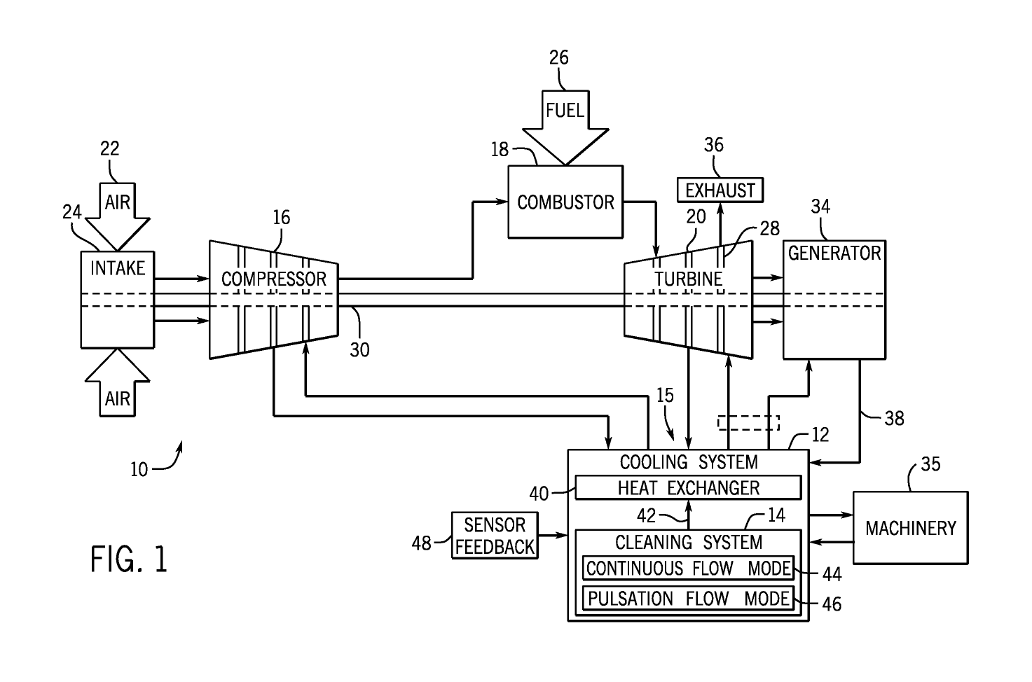

Turning now to the figures, FIG. 1 illustrates a block diagram of an embodiment of a gas turbine system 10 coupled to a cooling system 12 equipped with a cleaning system 14 that may clean and improve the efficiency of the cooling system 12. In certain embodiments, a cooling skid 15 may include both of the cooling system 12 and the cleaning system 14. As shown, the gas turbine system 10 includes a compressor 16, a combustor 18, and a turbine 20. The compressor 16 receives air 22 from an intake 24 and compresses the air 22 for delivery to the combustor 18. Fuel 26 is routed to the combustor 18 along with the air 22 at a ratio suitable for combustion, emissions, power output, and the like. The mixture of the air 22 and the fuel 26 is combusted, producing hot combustion products within the combustor 18. These hot combustion products enter the turbine 20 and force turbine blades 28 to rotate, thereby driving a shaft 30 of the gas turbine system 10 into rotation. The rotating shaft 30 may provide the energy for the compressor 16 to compress the air 22. More specifically, the rotating shaft 30 rotates compressor blades 32 attached to the shaft 30 within the compressor 16, thereby compressing the air 22 that is fed to the compressor 16. In addition, the rotating shaft 30 may rotate a load, such as an electrical generator 34 or any device capable of utilizing the mechanical energy of the shaft 30. After the turbine 20 extracts useful work from the combustion products, the combustion products are discharged to an exhaust 36.

During operation of the gas turbine system 10, certain components of the gas turbine system 10 may be subjected to high temperatures, which may reduce the operability or efficiency of these components. In order to counteract the reduced operability or efficiency caused by high temperatures, the cooling system 12 may route a fluid (e.g., lubricant and/or cooling fluid) 38 to lubricate and/or reduce the temperature of the compressor 16, the turbine 20, the generator 34, or any combination thereof. The cooling system 12 may be coupled to one or more other machines 35, such as pumps, turbines, compressors, rotary machines, turbomachines, electric motors, combustion engines, or any combination thereof. The cooling fluid 38 may include, for example, cooling water, a refrigerant, air, or another suitable heat transfer medium. As used herein, the term cooling fluid 38 is intended to cover any fluid (e.g., liquid and/or gas), which can be cooled to a lower temperature for cooling purposes, despite other functions (e.g., lubrication) of the fluid. In certain embodiments, the cooling fluid 38 may recirculate in a closed loop from the cooling system 12, through the gas turbine system 10, and back to the cooling system 12. In such a configuration, it may be desirable to remove heat from the cooling fluid 38 via one or more heat exchangers 40 in order to improve the efficiency of the cooling system 12.

Over time, an exterior surface of the heat exchanger 40 may foul or collect debris, which lowers the heat transfer efficiency of the heat exchanger 40. In order to counteract this decrease in efficiency, the cleaning system 14 may direct a cleaning fluid 42 along the exterior surface of the heat exchanger 40 to remove the fouling and debris. The cleaning fluid 42 may include, for example, instrument air, compressed air, nitrogen, another suitable gas, steam, a liquid, such as water or a cleaning solution, or any combination thereof.

In certain embodiments, the cleaning system 14 may include multiple modes of operation. For example, the cleaning system 14 may continuously flow the cleaning fluid 42 along the exterior surface of the heat exchanger 40 (e.g., a continuous flow mode 44), or the cleaning system 14 may pulse the cleaning fluid 42 at predetermined time intervals along the exterior surface of the heat exchanger 40 (e.g., a pulsation flow mode 46). The cleaning system 14 may receive sensor feedback 48 and may selectively enable, disable, or throttle flow of the cleaning fluid 42 based on the sensor feedback 48. For example, the sensor feedback 48 may be indicative of a heat transfer efficiency of the heat exchanger 40, and the cleaning system 14 may enable flow of the cleaning fluid 42 when the heat transfer efficiency drops below a threshold. Furthermore, the operating mode of the cleaning system 14 may be selected based on the sensor feedback 48. For example, the pulsation flow mode 46 may be activated when the sensor feedback 48 drops below a first threshold, and the continuous flow mode 44 may be activated when the sensor feedback 48 drops below a second threshold. That is, in certain embodiments, the pulsation flow mode 46 may be used for routine cleaning or maintenance of the heat exchanger 40, whereas the continuous flow mode 44 may be used when a greater degree of cleaning is desired, or vice versa. Furthermore, the cleaning system 14 may have a plurality of pulsation flow modes 46, each having a different frequency and/or amplitude (e.g., pressure of fluid pulsations). In certain embodiments, the cleaning system 14 may selectively use one or more of the pulsation flow modes 46 until the heat transfer efficiency improves; e.g., based on one or more thresholds and sensor feedback.

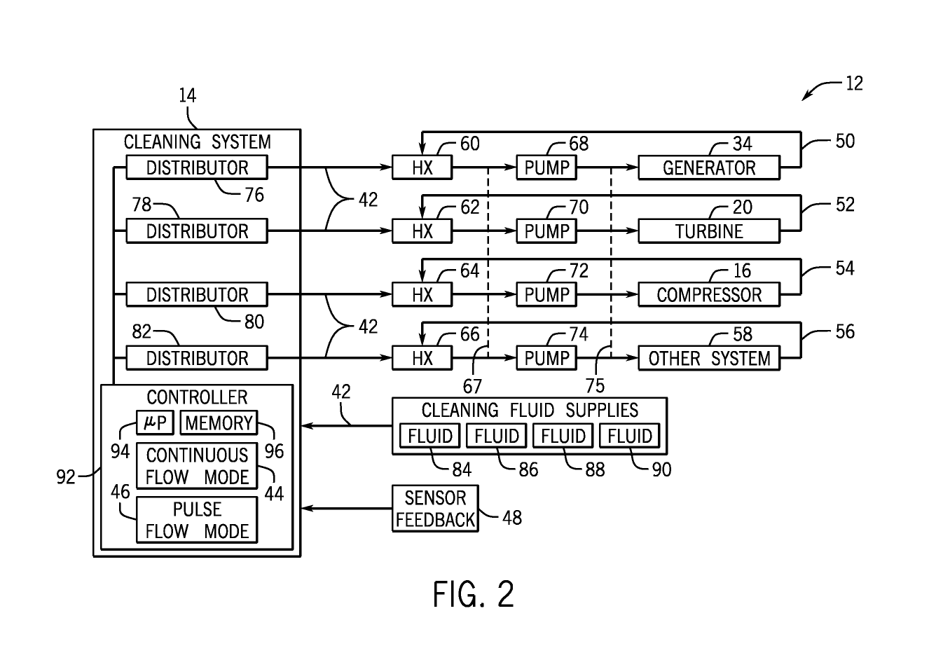

FIG. 2 illustrates an embodiment of the cooling system 12 with separate cooling fluid loops 50, 52, 54, and 56 to respectively cool the generator 34, the turbine 20, the compressor 16, and other systems 58 (e.g., machinery 35) within or outside of the gas turbine system 10. The cooling fluid loops 50, 52, 54, and 56 include respective heat exchangers 60, 62, 64, and 66 (e.g., 40) and pumps 68, 70, 72, and 74. In certain embodiments, each heat exchanger 60, 62, 64, and 66 (e.g., 40) may be dedicated to a single cooling fluid loop 50, 52, 54, or 56. In other embodiments, the heat exchangers 60, 62, 64, and 66 (e.g., 40) may be coupled to a distribution manifold 67, which may receive fluid from all of the heat exchangers and distribute the fluid to the pumps 68, 70, 72, and 74. In this manner, the distribution manifold 67 may enable heat exchanger redundancy, sharing, and/or increased cooling capacity for each of the cooling fluid loops 50, 52, 54, and 56. The pumps 68, 70, 72, and 74 may help to recirculate the cooling fluid 38 (e.g., coolant and/or lubricant) through each of the cooling fluid loops 50, 52, 54, and 56. In certain embodiments, each pump 68, 70, 72, and 74 may be dedicated to a single cooling fluid loop 50, 52, 54, or 56. In other embodiments, the pumps 68, 70, 72, and 74 may be coupled to a distribution manifold 75, which may receive fluid from all of the pumps and distribute the fluid to the target equipment (e.g., 34, 20, 16, and 58). In this manner, the distribution manifold 75 may enable pump redundancy, sharing, and/or increased pumping capacity for each of the cooling fluid loops 50, 52, 54, and 56. However, it should be noted that certain cooling fluid loops (e.g., natural convection loops) may not include pumps.

Each of the heat exchangers 60, 62, 64, and 66 may be subjected to fouling and may be cleaned independently of one another by the cleaning system 14. As shown, the cleaning system 14 receives the cleaning fluid 42 and directs the cleaning fluid 42 through one or more distributors 76, 78, 80, and 82 to clean the respective heat exchangers 60, 62, 64, and 66. As will be discussed in detail below, the distributors 76, 78, 80, and 82 may include a plurality of nozzles and/or orifices to meter and/or focus the cleaning fluid 42 along the exterior surfaces of the heat exchangers 60, 62, 64, and 66.

The cleaning fluid 42 may include one or more cleaning fluids (e.g., 84, 86, 88, and 90) from various sources, used alone or in some combination thereof. The cleaning fluids 84, 86, 88, and 90 may include liquids and/or gases, such as air, inert gas (e.g., nitrogen), steam, water solvents, soaps, cleaning chemicals, degreasers, or any combination thereof. Thus, the cleaning system 14 may mix fluids such as water and soap, air and solvent, air and degreasers, and so forth. The cleaning system 14 may also sequentially clean with one fluid 42 after another, such as sequential application of degreaser, water-soap solution, and gas (e.g., air). However, the cleaning system 14 may also have a default cleaning mode that relies on dry cleaning with a gas, such as air. For example, the cleaning fluid 84 may be supplied from an instrument air line, the cleaning fluid 86 may be supplied from a nitrogen storage tank, the cleaning fluid 88 may be supplied from an air compressor, and the cleaning fluid 90 may be supplied from a nitrogen line. In certain embodiments, the source of the cleaning fluid 42 may be based on a desired operating condition (e.g., temperature or pressure) of the cleaning fluid 42. For example, the various cleaning fluids 84, 86, 88, and 90 may be mixed together in a suitable ratio to obtain a desired operating condition (e.g., temperature or pressure) and/or cleaning mode (e.g., air, water/soap, degreaser, etc.) of the cleaning fluid 42 for delivery to the heat exchangers 60, 62, 64, and 66.

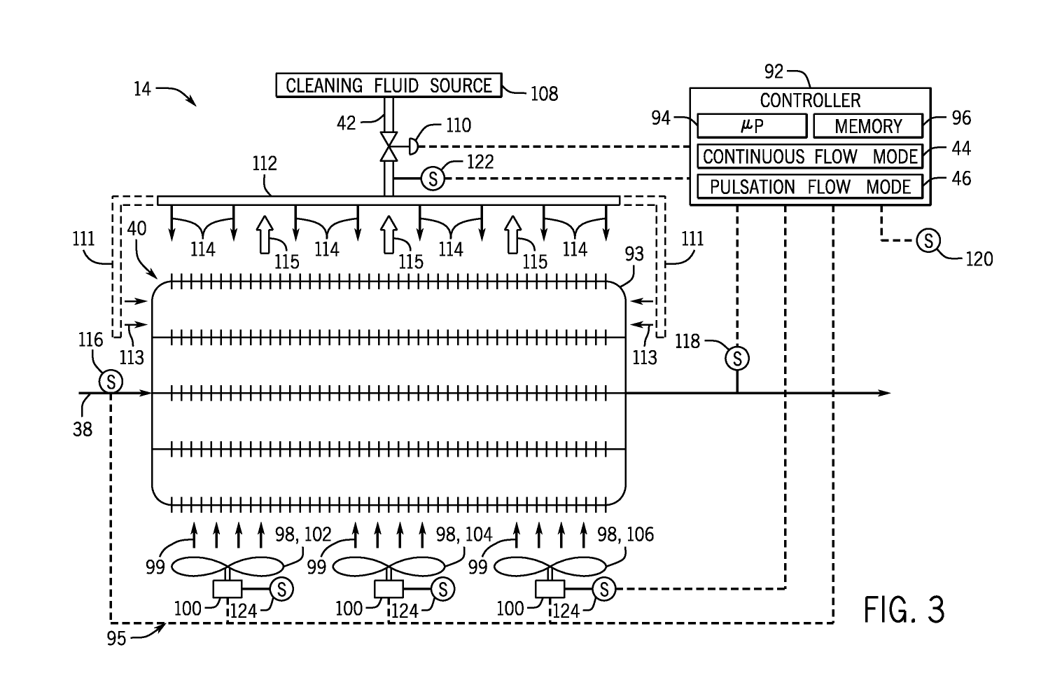

As shown, the cooling system 12 includes a controller 92 that may execute instructions to control operation of the cleaning system 14. For example, the controller 92 may execute instructions to adjust flows of each cleaning fluid 84, 86, 88, and 90 to obtain the cleaning fluid 42 with a desired operating condition (e.g., by controlling one or more valves) and/or cleaning mode. Additionally or alternatively, the controller 92 may execute instructions to selectively enable, disable, or throttle flow of the cooling fluid 42 to the various heat exchangers 60, 62, 64, and 66 (e.g., by controlling one or more valves). These instructions may be encoded in software programs that may be executed by a processor 94. In addition, the instructions may be stored in a tangible, non-transitory, computer-readable medium, such as memory 96. The memory 96 may include, for example, random-access memory, read-only memory, hard drives, and the like. As noted above, the cleaning system 14 may be activated when the sensor feedback 48 indicates a drop in heat transfer efficiency of the heat exchangers 60, 62, 64, and 66. Thus, as shown in FIG. 3, the controller 92 may receive feedback from a variety of sources and may use the feedback to estimate a heat transfer efficiency in order to determine when the cleaning system 14 may be activated. The cleaning system 14 also may operate on a schedule or time delay, such as every 6, 12, 24, or 48 hours, every week, every month, or other periodic time intervals.

FIG. 3 illustrates an embodiment of the heat exchanger 40 (e.g., air-cooled heat exchanger) that may be used to cool the cooling fluid 38. It should be noted that the heat exchanger 40 may be used to cool a variety of fluids, including process fluids, utility fluids (e.g., cooling water), lubricants (e.g., oils), and/or the like. As shown, the heat exchanger 40 includes a plurality of finned tubes 93. A bay 95 of one or more fans 98 blows ambient air along the finned tubes 93, thereby removing heat from the cooling fluid 38 within the tubes 93 via forced convection. The speed of each fan 98 is controlled by a respective motor 100 (e.g., electric motor). For example, the speed of the motor 100 may be increased in order to increase a speed of the fan 98, thereby increasing the rate at which air is blown across the finned tubes 93 and ultimately increasing the rate of heat removal from the cooling fluid 38 within the tubes 93. In certain embodiments, the speed of each fan 98 may be controlled independently. As will be appreciated, the operation (e.g., number and speed) of the fans 98 may be adjusted based on certain factors, such as the ambient air temperature and/or the inlet temperature of the cooling fluid 38, in order to target a specific outlet temperature of the cooling fluid 38. Thus, a first fan 102 may rotate with a first speed, a second fan 104 may rotate with a second speed, and a third fan 106 may rotate with a third speed, and each of the first, second, and third speeds may be different. Furthermore, a subset of the fans 98 may not rotate at all, depending on the desired outlet temperature of the cooling fluid 38.

Over time, debris and fouling may collect on an exterior surface of the heat exchanger 40 (e.g., on the finned tubes 93), which reduces the heat transfer efficiency of the heat exchanger 40. Without the disclosed cleaning system 14, the reduced heat transfer efficiency may result in higher fan speeds, longer durations of fan operation, greater numbers of fan usage, or any combination thereof. In other words, the cooling system 12 may consume more energy to compensate for the loss in heat transfer efficiency. If these measures are unsuccessful, the cooling system 12 and supported equipment may be taken offline for maintenance. As explained above, to avoid offline maintenance and increased energy usage, the cleaning system 14 may direct the cleaning fluid 42 in order to remove this debris, during operation of the heat exchanger 40. As illustrated, the cleaning system 14 is coupled to a cleaning fluid source 108 (e.g., 84, 86, 88, and/or 90). A control valve 110 is disposed along the flow path of the cleaning fluid 42 upstream of a distributor 112 (e.g., 76, 78, 80, or 82). The distributor 112 includes one or more outlets 114 that direct the cleaning fluid 42 (e.g., pressurized gas such as compressed air) across the finned tubes 93 (e.g., as a fluid jet, such as a compressed fluid or compressed air jet). The control valve 110 may be selectively opened, closed, or throttled in order to adjust the flow of the cleaning fluid 42 supplied to the distributor 112. For example, in the continuous flow mode 44 of operation, the control valve 110 may be left open to allow a continuous flow of the cleaning fluid 42 across the finned tubes 93. Additionally or alternatively, in the pulsation flow mode 46 of operation, the control valve 110 may be alternatingly opened and closed in order to create pulses of the cleaning fluid 42.

In the configuration shown, the bay 95 of the fans 98 is positioned below the finned tubes 93 and the distributor 112 of the cleaning system 14 is disposed above the finned tubes 93 (e.g., in an opposing relationship). Accordingly, the fans 98 blow ambient air 99 upwards towards the tubes 93, whereas the cleaning fluid 42 is directed downward onto the tubes 93, as indicated by arrows 114. In other words, the cleaning fluid 42 and the ambient air flow in opposite directions 114 and 99, e.g., directly opposite and parallel directions. Such a configuration may be desirable, as the debris removed by the cleaning system 14 may be subsequently blown away by the fans 98, as indicated by arrows 115.

In some embodiments, the distributor 112 may include one or more lateral distributor portions 111, which may be configured to direct a cleaning fluid flow 113 in a crosswise direction, e.g., perpendicular, relative to the direction of the air flow 99. For example, the lateral distributor portions 111 may be configured to direct the cleaning fluid flow 113 at an angle of between approximately 0 to 90, 10 to 80, 20 to 70, 30 to 60, or 40 to 50 degrees, or an angle of approximately 30, 45, 60, or 90 degrees relative to the direction of the air flow 99. The fans 98 and cleaning system 14 also may be arranged in other positions, such as any opposite sides, any adjacent sides, any common sides, or any combination thereof, wherein the sides may include top, bottom, left, right, rear, or front sides. While an opposing configuration (e.g., opposite sides) of the fans 98 and cleaning system 14 may be useful for providing directly opposite flows (e.g., 99 and 114) of the air and cleaning fluid, the adjacent configuration (e.g., a top side and a left or right side) arrangement of the fans 98 and cleaning system 14 may be useful for providing crosswise flows (e.g., perpendicular flows) of the air 99 and cleaning fluid 113. By further example, the fans 98 and the cleaning system 14 may both be above or below the finned tubes 93, and their positions may be generally interchangeable in certain embodiments.

Again, the cleaning system 14 may include a continuous flow mode 44 and one or more pulsation flow modes 46, which may employ different frequencies and amplitudes of pressure waves applied to the surfaces of the finned tubes 93. These pressure waves may help to break up, break loose, or otherwise remove debris from the surface of the heat exchanger 40, such that the air flow from the fans 98 can then carry the debris away from the heat exchanger 40. For example, the pulsation flow modes 46 may include a plurality of different frequencies, one or more patterns of changing frequencies (e.g., the frequency changes according to some predefined pattern), a smart frequency mode (e.g., the frequency changes based on feedback indicating success of certain frequencies at cleaning the heat exchanger), or any combination thereof. By further example, the pulsation flow modes 46 may include a series of different patterns of pulsations, e.g., a first frequency of pulsations, a second frequency of pulsations, a third frequency of pulsations, etc., wherein each of the frequencies is different (e.g., progressively increasing, decreasing, or alternating between high and low frequencies). The pulsation flow modes 46 also may include a continuously variable frequency mode, which may gradually increase the frequency, gradually decrease the frequency, or gradually increase and decrease the frequency in some alternating pattern. Furthermore, pulsation flow modes 46 also may include a stepwise variable frequency mode, which may increase the frequency in a plurality of steps, decrease the frequency in a plurality of steps, or increase and decrease the frequency in a plurality of steps in some alternating pattern. The pulsation flow mode 46 may include both an automated pulsation flow mode and a manual pulsation flow mode, wherein the automated mode may rely on preprogrammed selections and/or sensor feedback while the manual mode may rely on some manual user selections and/or adjustments.

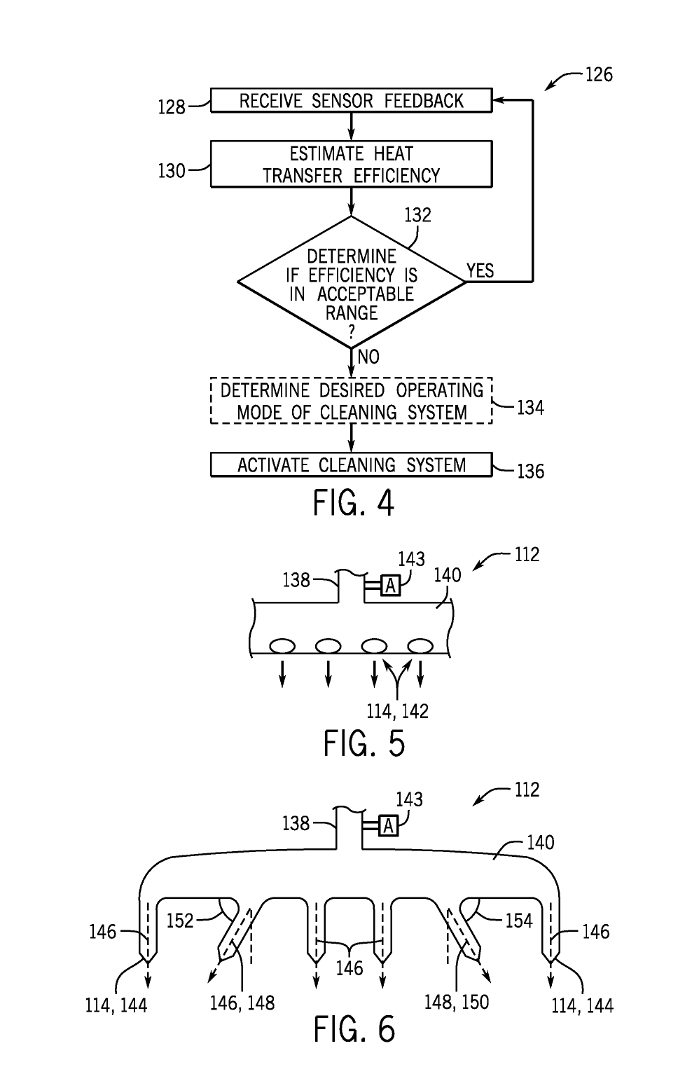

As shown, the controller 92 is communicatively coupled to the control valve 110 and each motor 100 of each fan 98. The controller 92 may adjust the valve 110 and the speed of each motor 100 based on feedback from one or more sensors. In the embodiment shown, the controller 92 receives feedback from an inlet cooling fluid sensor 116, an outlet cooling fluid sensor 118, an ambient air sensor 120, a cleaning fluid sensor 122, and one or more motor sensors 124. Each of the sensors 116, 118, 120, 122, and 124 detects one or more operating conditions associated with their respective components. For example, the inlet cooling fluid sensor 116 may detect an inlet temperature of the cooling fluid 38, the outlet cooling fluid sensor 118 may detect an outlet temperature of the cooling fluid 38, the ambient air sensor 120 may detect a temperature of the ambient air, the cleaning fluid sensor 122 may detect a pressure and/or flow rate of the cleaning fluid 42, and the motor sensor 124 may detect a speed of the motor 100 or fan 98. It should be noted the aforementioned operating conditions are given by way of example, and are not intended to be limiting. Indeed, the sensors 116, 118, 120, 122, and 124 may detect other suitable parameters (e.g., machinery feedback, such as from the gas turbine system 10), and any combinations thereof. For example, the machinery feedback may include gas turbine engine feedback, which may be indicative of a loss in heat transfer efficiency of the heat exchanger 40. After receiving feedback from the sensors 116, 118, 120, 122, and 124, the controller 92 may determine when the cleaning system 14 may be activated, as discussed below with respect to FIG. 4.

FIG. 4 is a flow chart of an embodiment of a method 126 to automatically and algorithmically activate the cleaning system 14 in response to a decreased heat transfer efficiency of the cooling system 12. It should be noted that in certain embodiments, manual operation (e.g., by an operator) of the cleaning system 14 may be desirable. As noted above, the controller 92 receives (block 128) feedback from the one or more sensors 116, 118, 120, 122, and 124. The controller 92 calculates or estimates (block 130) a parameter indicative of the heat transfer efficiency of the cooling system 12. To this end, the controller 92 may calculate approach temperatures (e.g., of the cooling fluid 38), heat transfer coefficients, effective cross-sectional surface areas of the heat exchanger 40, fouling factors, and/or the like in order to estimate the heat transfer efficiency. As will be appreciated, the heat transfer efficiency may be affected by several factors, such as the temperature of the ambient air, the number and speed of the fans 98, the inlet and outlet temperatures of the cooling fluid 38, among other factors. Different heat transfer models may utilize different factors, and may assign varying degrees of importance to each factor.

After estimating (block 130) the heat transfer efficiency, the controller 92 determines (block 132) if the efficiency is in an acceptable range. In certain embodiments, the controller 92 may compare the efficiency to a threshold stored in the memory 96 of the controller 92. If the efficiency is below the threshold, the controller 92 may determine (block 132) that the efficiency is not in an acceptable range. When the efficiency is not in the acceptable range, the controller 92 may optionally determine (block 134) a desired operating mode of the cleaning system (e.g., based on the magnitude of the difference between the estimated efficiency and the threshold). For example, the controller 92 may determine (block 134) that the continuous flow mode 44 or the pulsation flow mode 46 is desirable, based on the sensor feedback 48. The controller 92 then activates (block 136) the cleaning system 14, by, for example, opening the control valve 110 to enable the cleaning fluid 42 to flow to the distributor 112 of the cleaning system 14. The controller 92 may continue to receive (block 126) feedback from the sensors 116, 118, 120, 122, and 124 and continue to monitor the heat transfer efficiency of the cooling system 12.

The geometry of the distributor 112 (e.g., 76, 78, 80, and 82) is discussed below with respect to FIGS. 5 and 6. Turning now to FIG. 5, the distributor 112 includes a main line 138 that branches into a manifold 140 having the plurality of outlets 114. In particular, the manifold 140 includes one or more orifices 142 that focus and/or meter flow of the cleaning fluid 42 to the finned tubes 93 of the heat exchanger 40. In certain embodiments, the width of the orifices 142 may vary. For example, the orifices 142 closest to the main line 138 may have smaller widths than the orifices 142 further away from the main line 138, thereby helping to equalize the flow of the cleaning fluid 42 among the orifices 142. The distributor 112 may also include a positioning system, such as a robotic arm or actuator 143, which may be controlled to move the orifices 142 in a cleaning pattern over the heat exchanger.

As shown in FIG. 6, a portion of the outlets 114 may be equipped with nozzles 144 that help to direct the flow of the cleaning fluid 42 toward the finned tubes 93 of the heat exchanger 40. As shown, the nozzles 144 direct the cleaning fluid along respective axes 146 relative to the manifold 140. A portion of the axes are generally perpendicular to the manifold 140, whereas certain axes (e.g., 148 and 150) are non-perpendicular. Indeed, the axes 148 and 150 form acute angles 152 and 154 with the manifold. For example, the acute angles 152 and 154 may be approximately 10 to 80, 20 to 70, 30 to 60, or 40 to 50 degrees. As will be appreciated, it may be desirable to orient the nozzles 144 in such a manner to direct the cleaning fluid 42 toward areas of the finned tubes 93 with higher anticipated rates of fouling and/or debris buildup. Furthermore, it should be noted that certain embodiments may employ the orifices 142 and the nozzles 144 in combination with one another, depending on the desired flow rates and/or distributions of the cleaning fluid 42.

Technical effects of the disclosed embodiments include systems and methods to clean the heat exchanger 40. In particular, the cleaning system 14 may direct the cleaning fluid 42 along an exterior surface of the heat exchanger 40 (e.g., the finned tubes 93) in order to clear fouling and debris that accumulates on the exterior surface. For example, the cleaning fluid 42 may be air, and the cleaning system 14 may direct pulses of compressed air or a continuous flow of pressurized air along the exterior surface of the heat exchanger 40. The cleaning system 14 may include the sensors 116, 118, 120, 122, and 124 and the controller 92 to enable automatic activation of the cleaning system 14. That is, the sensors 116, 118, 120, 122, and 124 may detect a decrease in cooling efficiency, and the controller 92 may open one or more valves 110 to enable flow of the cleaning fluid 42 across the exterior surface of the heat exchanger 40. Advantageously, the cleaning system 14 may be used during operation of the heat exchanger 40, thereby enabling the heat exchanger 40 to be cleaned without taking the heat exchanger 40 and gas turbine system 10 offline.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a cooling system, comprising:
a first pump;
a heat exchanger;
a liquid flow path through the first pump and the heat exchanger;
a first cooling fan; and
an airflow path through the first cooling fan and along an exterior surface of the heat exchanger;
a cleaning system comprising at least one fluid outlet configured to direct a fluid jet against the exterior surface of the heat exchanger to clean the exterior surface during operation of the cooling system.

2. The system of claim 1, comprising a cooling skid having the cooling system and the cleaning system.

3. The system of claim 1, comprising a turbine, a generator, or a combination thereof, coupled to the cooling system.

4. The system of claim 3, wherein the cleaning system is configured to direct the fluid jet from the at least one fluid outlet against the exterior surface of the heat exchanger to clean the exterior surface during operation of the turbine or the generator.

5. The system of claim 1, wherein the cleaning system comprises a manifold having a plurality of fluid outlets, and each fluid outlet is configured to direct a respective fluid jet against the exterior surface of the heat exchanger to clean the exterior surface during operation of the cooling system.

6. The system of claim 5, wherein each fluid outlet of the plurality of fluid outlets comprises an orifice or a fluid nozzle.

7. The system of claim 5, wherein each fluid outlet of the plurality of fluid outlets has a different outlet width.

8. The system of claim 5, wherein each fluid outlet of the plurality of fluid outlets has an outlet axis at a different angle relative to the manifold.

9. The system of claim 1, wherein the airflow path has a first flow direction through the first cooling fan and along the exterior surface of the heat exchanger, the cleaning system is configured to direct the fluid jet from the at least one fluid outlet against the exterior surface of the heat exchanger in a second flow direction, wherein the first and second directions are different from one another.

10. The system of claim 9, wherein the first and second directions are opposite or crosswise relative to one another.

11. The system of claim 1, wherein the cleaning system is configured to pulse the fluid jet from the at least one fluid outlet against the exterior surface of the heat exchanger to clean the exterior surface during operation of the cooling system.

12. The system of claim 1, wherein the cleaning system is configured to couple to a compressed air supply, and the fluid jet comprises a compressed air jet.

13. The system of claim 1, comprising a controller coupled to the cleaning system, wherein the controller is configured to activate the cleaning system in response to a control signal during operation of the cooling system.

14. The system of claim 1, wherein the controller is configured to activate the cleaning system in response to the control signal based on sensor feedback, and the sensor feedback is indicative of a loss in efficiency of the heat exchanger.

15. A system, comprising:
a cleaning system comprising at least one fluid outlet configured to direct a fluid jet against an exterior surface of a heat exchanger to clean the exterior surface during operation of a cooling system; and
a controller coupled to the cleaning system, wherein the controller is configured to activate the cleaning system in response to a control signal during operation of the cooling system.

16. The system of claim 15, wherein the cleaning system comprises a manifold configured to couple to a compressed air supply, and the manifold has a plurality of fluid outlets configured to direct a plurality of compressed air jets against the exterior surface of the heat exchanger to clean the exterior surface during operation of the cooling system.

17. The system of claim 15, wherein the cleaning system is configured to pulse the fluid jet from the at least one fluid outlet against the exterior surface of the heat exchanger to clean the exterior surface during operation of the cooling system.

18. The system of claim 15, wherein the control signal is based on sensor feedback indicative of a loss in efficiency of the heat exchanger.

19. A system, comprising:
a cleaning system controller having a non-transitory, machine-readable medium comprising instructions executable by a processor, wherein the instructions comprise:
estimating a parameter indicative of heat transfer efficiency using feedback from one or more sensors;
determining if the parameter is within a range; and
enabling flow of a cleaning fluid along an exterior surface of an air-cooled heat exchanger when the parameter is within the range.

20. The system of claim 19, wherein the air-cooled heat exchanger is configured to cool water, and wherein the parameter indicative of the heat transfer efficiency comprises an approach temperature of the water, an ambient temperature, or both.
